(19) United States
(12) Patent Application Publication
(10) Pub. No.: US 2026/0341831 A1
(43) Pub. Date: Oct. 29, 2026

(54) BATTERY CELL

(71) Applicants: Volkswagen Aktiengesellschaft, Wolfsburg (DE); PowerCo SE, Salzgitter (DE)

(72) Inventors: Matthias TOMECKI, Braunschweig (DE); Marvin CZECH, Braunschweig (DE); Mesut YURTSEVEN, Salzgitter (DE); Bastian SCHAAR, Braunschweig (DE); Anish GAUSH, Lengede (DE); Joan Malagarriga DUARTE, Essenrode (Lehre) (DE)

(73) Assignees: Volkswagen Aktiengesellschaft, Wolfsburg (DE); PowerCo SE, Salzgitter (DE)

(21) Appl. No.: 19/700,820

(22) Filed: Jun. 8, 2026

Related U.S. Application Data
(63) Continuation of application No. PCT/EP2024/085082, filed on Dec. 6, 2024.

(30) Foreign Application Priority Data
Dec. 8, 2023 (DE) 10 2023 212 409.2

(51) Int. Cl. H01M 10/653; H01M 10/613; H01M 10/625; H01M 10/647; H01M 50/103; H01M 50/188; H01M 50/19; H01M 50/548; H01M 50/557

(52) U.S. Cl. CPC H01M 10/653; H01M 10/613; H01M 10/625; H01M 10/647; H01M 50/103; H01M 50/188; H01M 50/19; H01M 50/548; H01M 50/557; H01M 2220/20

(57) ABSTRACT

A battery cell having a cell housing and a cell terminal, preferably an external contact element. At least one heat conductor is arranged between the cell terminal, preferably the external contact element, and the cell housing. The external contact element is connected to the cell housing in a thermally conductive manner, and preferably in an electrically insulating manner, via the heat conductor.

This nonprovisional application is a continuation of International Application No. PCT/EP2024/085082, which was filed on Dec. 6, 2024, and which claims priority to German Patent Application No. 10 2023 212 409.2, which was filed in Germany on Dec. 8, 2023, and which are both herein incorporated by reference.

### BACKGROUND OF THE INVENTION

### Field of the Invention

The invention relates to a battery cell.

### Description of the Background Art

A generic battery cell heats up during charging and discharging, in particular primarily in the area of a cell core of the battery cell. However, in particular under fairly high current load and due to ohmic losses in a cell terminal of the battery cell, the battery cell may also heat up significantly in the area of the cell terminal, in some cases even more intensely than in the cell core. Since the cell terminal is thermally connected to the cell core, the heat may be transferred from the cell terminal to the cell core. This causes the area of the cell core near the terminal, as well as the cell terminal, to heat up considerably, and a so-called “hot spot” is formed which increases the charging time necessary for full charging of the battery cell. The battery cell thus has the drawback that the hot spot that forms lowers the charging performance of the battery cell.

A cell module is known from DE 10 2016 223 063 A1.

### SUMMARY OF THE INVENTION

It is therefore an object of the present invention to provide a battery cell having better charging performance compared to a known battery cell.

According to an example of the invention, a battery cell having a cell housing and a cell terminal, preferably an external contact element, is provided. At least one heat conductor is situated between the cell terminal, preferably the external contact element, and the cell housing, it preferably being provided that the external contact element is connected via the heat conductor to the cell housing in a heat-conducting and preferably electrically insulating manner. This has the advantage that heat is transferred from the cell terminal, preferably from the external contact element, to the cell housing via the heat conductor. The formation of a hot spot in the area of a cell core of the battery cell near the terminal may thus be prevented. The charging performance of the battery cell is thus increased in a structurally simple manner. The cell housing then transfers the heat to cooling plates of a cooling system for the battery cell, with the cooling plates being in heat-conducting connection with the cell housing.

To obtain a battery cell that is technically simple to manufacture, it may be provided, for example, that the external contact element and/or an insulating element of the battery cell are/is part(s) of a cell terminal of the battery cell, and/or that the external contact element is connected, preferably electrically, to the cell core of the battery cell, preferably to an electrode of the battery cell, preferably of the cell core, via a connecting element, preferably a connecting bolt.

To reliably protect a cell core of the battery cell, preferably electrodes of the cell core, from mechanical influences, it may preferably be provided that the cell housing delimits a housing interior on the outside, wherein it is preferably provided that the cell core, preferably one or more electrodes of the battery cell, is/are situated in the housing interior.

For reliable electrical insulation and simplified assembly of the battery cell, and to ensure that no electrical current flows between the cell housing and the insulating element, in an example, it may be provided that the battery cell has an insulating element, and that the insulating element, preferably for insulation with respect to electrical current flow, is situated between the cell housing and the external contact element, and that a first opening and/or a second opening are/is associated with the insulating element.

To promote the mechanical stability of the insulating element, it may preferably be provided that the first opening and/or the second opening are/is delimited from the insulating element on the outside. For example, it may be provided that the first opening and/or the second opening have/has the geometry of a circular cylinder or a cuboid.

In order for the cell terminal to take up as little installation space as possible, it may be provided, for example, that the insulating element has an essentially U-shaped cross section, and/or that the insulating element is essentially trough-shaped.

To enable defined heat transfer between the external contact element and the cell housing in a structurally simple manner, in an example it may be provided that the heat conductor is formed, at least in part, by a first opening heat conduction material and/or by a second opening heat conductor, wherein it is provided that the first opening heat conduction material is situated in the first opening, and/or wherein it is provided that the second opening heat conduction material is situated in the second opening.

For the most effective and efficient heat transfer possible, in an example, it may be provided that the external contact element is preferably in direct contact and/or preferably in direct contact in a heat-conducting manner and/or preferably in direct contact in an electrically insulating manner, with the first opening heat conductor and/or the second opening heat conductor, and/or that the cell housing, preferably a cover of the cell housing, is preferably in direct contact and/or preferably in direct contact in a heat-conducting manner and/or preferably in direct contact in an electrically insulating manner, with the first opening heat conductor and/or the second opening heat conductor.

In order for the battery cell to be easily integrated into a cell stack or into a combination of battery cells, in an example it may be provided that the battery cell has a cell connector, wherein it is provided that the cell connector is electrically connected, preferably directly, to the cell terminal, preferably to the external contact element, and/or wherein it is provided that the cell connector is connected, preferably directly, to a connecting element of the battery cell.

To enable not only heat transfer between the cell terminal and the cell housing, but additionally or alternatively, heat transfer from the cell connector to the cell housing in a structurally simple manner, in an example it may be provided that the heat conductor is formed, at least in part, by a first connector heat conductor and/or by a second connector heat conductor, wherein it is provided that the first connector heat conductor and/or the second connector heat conductor are/is situated between the cell connector and the cell housing, preferably a cover of the cell housing, wherein it is preferably provided that the cell connector is connected to the cell housing, preferably to a cover of the cell housing, in a heat-conducting and preferably electrically insulating manner, via the first connector heat conductor and/or via the second connector heat conductor.

To allow particularly simple manufacture of the cell connector, in an example it may be provided that the cell connector has a base section as well as a first leg and/or a second leg, wherein it is preferably provided that the base section lies flatly against the external contact element, and/or wherein it is preferably provided that the first leg and/or the second leg protrude(s) from the base section, preferably at right angles to a longitudinal axis of the connecting element of the battery cell, in the direction of the cell housing, preferably in the direction of a cover of the cell housing.

To achieve the heat transfer from the cell connector to the cell housing in a particularly structurally simple manner, in an example it may be provided that the first leg has a front face that faces the cell housing, preferably faces a cover of the cell housing, and that the first connector heat conductor is situated between the front face of the first leg and the cell housing, preferably a cover of the cell housing, and/or that the second leg has a front face that faces the cell housing, preferably faces a cover of the cell housing, and that the second connector heat conductor is situated between the front face of the second leg and the cell housing, preferably a cover of the cell housing.

To reliably prevent slippage of the connector heat conductor relative to the cell connector, in an example it may be provided that a first collar of the first leg adjoins the front face of the first leg in the direction of the cell housing, preferably in the direction of a cover of the cell housing, wherein it is provided that an inner side of the first collar of the first leg together with the front face of the first leg delimits a first receiving pocket on the outside, in which the first connector heat conductor is at least partially situated, and/or that a second collar of the second leg adjoins the front face of the second leg in the direction of the cell housing, preferably in the direction of a cover of the cell housing, wherein it is provided that an inner side of the second collar of the second leg together with the front face of the second leg delimits a second receiving pocket on the outside, in which the second connector heat conductor is at least partially situated.

To achieve particularly effective, efficient heat transfer at low cost, in an example it may be provided that the heat conductor is formed by a thermally conductive mat and/or by a preferably curable and/or cured thermally conductive paste, and/or the first opening heat conductor and/or the second opening heat conductor, and/or the first connector heat conductor and/or the second connector heat conductor, preferably in each case is/are formed by a thermally conductive mat and/or by a preferably curable and/or cured thermally conductive paste.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a sectional side view of a detail of a battery cell, wherein an external contact element of the battery cell is connected to a cell housing of the battery cell in a heat-conducting manner via opening heat conductor;

FIG. 2 shows a sectional side view of the battery cell according to FIG. 1, wherein a cell connector of the battery cell is additionally connected to a cell housing of the battery cell in a heat-conducting manner via connector heat conductor;

FIG. 3 shows a perspective view of the battery cell according to FIG. 2, and

FIG. 4 shows a perspective view of one half of the cell connector.

### DETAILED DESCRIPTION

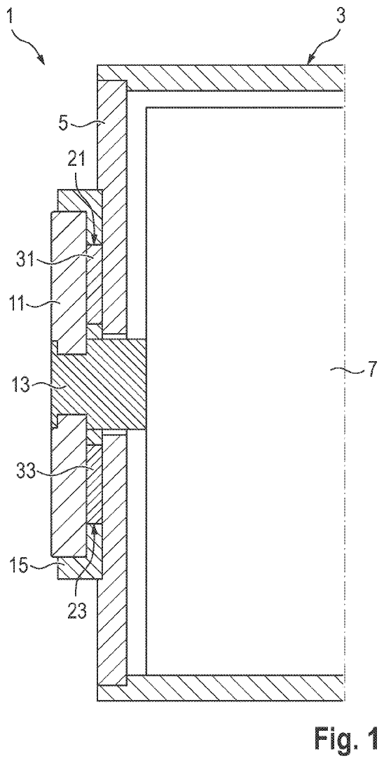

FIG. 1 shows a battery cell 1 for a traction battery of a battery-powered vehicle. The battery cell 1 has a cell housing 3 with a cover 5 that rests against housing cover walls of the cell housing 3. The cell housing 3 delimits a housing interior on the outside. In addition, the battery cell 1 has a cell core 7 that is formed, at least in part, by electrodes of the battery cell 1. The cell core 7 is situated in the housing interior.

Furthermore, the battery cell 1 has a cell terminal. The cell terminal has an external contact element 11 which, strictly by way of example here, has a plate-shaped geometry. The external contact element 11 is electrically, mechanically, and thermally connected to the cell core 7 via a connecting element 13. The connecting element 13, strictly by way of example here, is formed by a connecting element.

A trough-shaped insulating element 15, strictly by way of example here, is situated between the external contact element 11 and the cover 5. The insulating element 15 is designed and/or suited for preventing electrical current from flowing between the external contact element 11 and the cover 5. A first opening 21 and a second opening 23 are associated with the insulating element 15, and each is completely delimited by the insulating element 15 on the outside.

In general, a heat conductor is situated between the cell terminal, in particular the external contact element 11, and the cell housing 3, in particular the cover 5, wherein the external contact element 11 is connected to the cover 5 in a heat-conducting and electrically insulating manner via the heat conductor. Heat is thus directly transferred from the external contact element 11 to the cover 5 via the heat conductor.

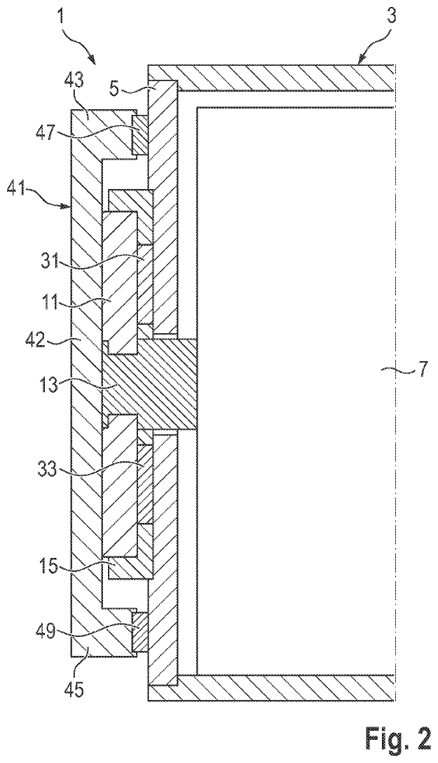

In the example of the battery cell 1 illustrated in FIGS. 1 and 2, the heat conductor is formed partly by a first opening heat conductor 31 and partly by a second opening heat conductor 33. The first opening heat conductor 31 is situated in the first opening 21, and has direct contact with the external contact element 11 as well as direct contact with the cover 5. The second opening heat conductor 33 is situated in the second opening 23, and has direct contact with the external contact element 11 as well as direct contact with the cover 5.

As illustrated in FIG. 2, the battery cell 1 additionally has an essentially C-shaped cell connector 41. The cell connector 41 has a base section 42 as well as a first leg 43 and a second leg 45. The first leg 43 and the second leg 45 each protrude at right angles from the base section 42 in the direction of the cover 5. The cell connector 41 with its base section 42 lies flatly on the external contact element 11 and, strictly by way of example here, is directly electrically connected to the cell terminal, in particular the external contact element 11. In addition, the cell connector 41, strictly by way of example here, is directly electrically connected to the connecting bolt 13.

The heat conductor is formed partly by a first connector heat conductor 47 and partly by a second connector heat conductor 49. The first connector heat conductor 47 is situated between the cell connector 41, in particular the first leg 43, more particularly a front face of the first leg 43, and the cover 5. The first leg 43, in particular the front face of the first leg 43, is directly connected to the first connector heat conductor 47 in a heat-conducting and electrically insulating manner, and the first connector heat conductor 47 is directly connected to the cover 5 in a heat-conducting and electrically insulating manner. The second connector heat conductor 49 is situated between the cell connector 41, in particular the second leg 45, more particularly a front face of the second leg 45, and the cover 5. The second leg 45, in particular the front face of the second leg 45, is directly connected to the second connector heat conductor 49 in a heat-conducting and electrically insulating manner, and the second connector heat conductor 49 is directly connected to the cover 5 in a heat-conducting and electrically insulating manner.

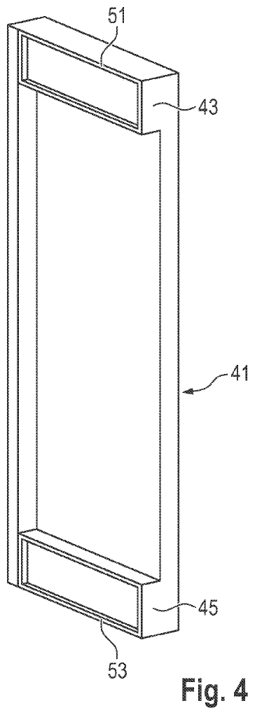

As shown in particular in FIG. 2, a first collar 51 of the first leg 43 adjoins the front face of the first leg 43 in the direction of the cover 5, as is particularly apparent in FIG. 4. An inner side of the first collar 51 of the first leg 43, together with the front face of the first leg 43, delimits a first receiving pocket on the outside, in which the first connector heat conductor 47 is at least partially situated. A second collar 53 of the second leg 45 adjoins the front face of the second leg 45 in the direction of the cover 5. An inner side of the second collar 53 of the second leg 45, together with the front face of the second leg 45, delimits a second receiving pocket on the outside, in which the second connector heat conductor 49 is at least partially situated.

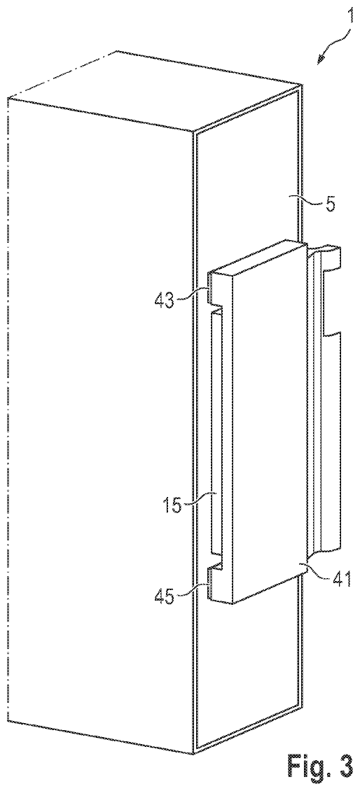

FIG. 3 likewise shows a detail of the battery cell 1 in a perspective view. The cell connector 41, the insulating element 15, the cover 5, as well as the first connector heat conductor 47 and the second connector heat conductor 49, among other things, are apparent in FIG. 4.

It is expressly pointed out that in this or another example of the battery cell 1, the external contact element 11 by way of example is also connected in a heat-conducting manner to the cover 5 only via one or both of the opening heat conductor 31 and 33, or also only via one or both of the connector heat conductor 47 and 49, preferably with the cell connector 41 in between. It is also conceivable that in this or another example of the battery cell 1, the external contact element 11 by way of example is connected in a heat-conducting manner to the cover 5 only via one of the opening heat conductor 31 or 33, and only via one of the connector heat conductor 47 or 49.

In the battery cell 1, the first opening heat conductor 31 and the second opening heat conductor 33, and the first connector heat conductor 47 and the second connector heat conductor 49, are in each case formed by a thermally conductive mat. However, in this or another example of the battery cell 1, the first opening heat conductor 31 and/or the second opening heat conductor 33, and/or the first connector heat conductor 47 and/or the second connector heat conductor 49, may in each case preferably be formed by a thermally conductive mat and/or by a preferably curable and/or cured thermally conductive paste and/or by a preferably curable and/or cured thermally conductive adhesive.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery cell having:
a cell housing;
a cell terminal that is formed as an external contact element;
at least one heat conductor is arranged between the cell terminal or the external contact element and the cell housing,
wherein the external contact element is connected to the cell housing in a thermally conductive manner and in an electrically insulating manner via the heat conductor.

2. The battery cell according to claim 1, wherein the battery cell has an insulating element, wherein the insulating element, provided for insulation with respect to electrical current flow, is arranged between the cell housing and the external contact element, and wherein a first opening and/or a second opening are associated with the insulating element.

3. The battery cell according to claim 2, wherein the heat conductor is formed, at least in part, by a first opening heat conductor and/or by a second opening heat conductor, wherein the first opening heat conductor is arranged in the first opening, and/or wherein the second opening heat conductor is arranged in the second opening.

4. The battery cell according to claim 3, wherein the external contact element is in direct contact and/or in direct contact in a heat-conducting manner and/or in direct contact in an electrically insulating manner, with the first opening heat conductor and/or the second opening heat conductor, and/or wherein the cell housing or a cover of the cell housing is in direct contact and/or in direct contact in a heat-conducting manner and/or in direct contact in an electrically insulating manner with the first opening heat conductor and/or the second opening heat conductor.

5. The battery cell according to claim 1, wherein the battery cell has a cell connector, wherein the cell connector is electrically connected or directly to the cell terminal or to the external contact element, and/or wherein the cell connector is connected or directly connected to a connector of the battery cell.

6. The battery cell according to claim 5, wherein the heat conductor is formed, at least in part, by a first connector heat conductor and/or by a second connector heat conductor, wherein the first connector heat conductor and/or the second connector heat conductor are arranged between the cell connector and the cell housing or a cover of the cell housing, wherein the cell connector is connected to the cell housing or a cover of the cell housing in a heat-conducting and electrically insulating manner via the first connector heat conductor and/or via the second connector heat conductor.

7. The battery cell according to claim 5, wherein the cell connector has a base section and as a first leg and/or a second leg, wherein the base section lies flatly against the external contact element, and/or wherein the first leg and/or the second leg protrude from the base section at right angles to a longitudinal axis of the connector of the battery cell in a direction of the cell housing or in a direction of a cover of the cell housing.

8. The battery cell according to claim 7, wherein the first leg has a front face that faces the cell housing or faces a cover of the cell housing, and wherein the first connector heat conductor is arranged between the front face of the first leg and the cell housing or a cover of the cell housing, and/or wherein the second leg has a front face that faces the cell housing or faces the cover of the cell housing, and wherein the second connector heat conductor is arranged between the front face of the second leg and the cell housing or the cover of the cell housing.

9. The battery cell according to claim 8, wherein a first collar of the first leg adjoins the front face of the first leg in the direction of the cell housing or in the direction of the cover of the cell housing, wherein an inner side of the first collar of the first leg together with a front face of the first leg delimits a first receiving pocket on an outside, in which the first connector heat conductor is at least partially arranged, and/or wherein a second collar of the second leg adjoins the front face of the second leg in the direction of the cell housing or in the direction of the cover of the cell housing, wherein an inner side of the second collar of the second leg together with the front face of the second leg delimits a second receiving pocket on the outside, in which the second connector heat conductor is at least partially arranged.

10. The battery cell according to claim 1, wherein the heat conductor is formed by a thermally conductive mat or by a curable or cured thermally conductive paste, and/or wherein the first opening heat conductor and/or the second opening heat conductor, and/or the first connector heat conductor, and/or the second connector heat conductor, are formed by a thermally conductive mat or by a curable or cured thermally conductive paste.
